(19) United States
(12) Patent Application Publication
(10) Pub. No.: US 2012/0223232 A1
(43) Pub. Date: Sep. 6, 2012

(54) GAS DETECTION DEVICE

(75) Inventor: Masashi Kubota, Tokyo (JP)

(73) Assignee: NEC CORPORATION, Minato-ku, Tokyo (JP)

(21) Appl. No.: 13/509,913

(22) PCT Filed: Oct. 26, 2010
(86) PCT No.: PCT/JP2010/068921

§ 371 Date: May 15, 2012

(30) Foreign Application Priority Data
Nov. 17, 2009 (JP) 2009-261817

(51) Int. Cl. G01N 21/59

(52) U.S. Cl. 250/338.5

(57) ABSTRACT

A gas detection device of the present invention includes: a laser light source which emits wavelength-variable laser light to an optical waveguide; a bolometer which obtains a detection signal by detecting output light from the optical waveguide, and has a microbridge structure having a temperature detection unit and a dielectric member arranged above the temperature detection unit; a detection unit which detects a type and amount of gas molecules present on a surface of the optical waveguide based on the detection signal and information of a wavelength of the laser light source; an optical path length change member which changes an optical path length between the temperature detection unit and the dielectric member; and a driving control circuit which performs driving control of the optical path length change member such that the optical path length becomes an integer multiple of a half wavelength of the laser light emitted from the laser light source.

### TECHNICAL FIELD

The present invention relates to a gas detection device using a bolometer. Specifically, the invention relates to a bolometer capable of detecting a signal with high sensitivity even when the wavelength of an input signal changes and a highly sensitive gas detection device which is realized by connecting the bolometer to a wavelength variable laser and a waveguide.

### BACKGROUND ART

Recently, in the field of environmental sensing which aims to measure greenhouse gases, volatile organic compounds, or the like present in the atmosphere, in indoor atmospheres, or the like, there has been an increasing demand for gas detection devices using the absorption of light from the infrared light region to the terahertz (THz) wavelength region.

For example, carbon dioxide (CO₂), which is a representative greenhouse gas, shows a strong absorption peak centered on 4.3 μm or 14.5 μm in the infrared region. Therefore, it is possible to detect CO₂ by measuring the absorption spectrum in these wavelength bands.

As gas detection devices using the absorption of light in the infrared region, for example, the passive type gas detection device disclosed in Patent Document 1 and the active type gas detection device disclosed in Patent Document 3 are known.

The gas measuring apparatus disclosed in Patent Document 1 calculates the surface density of the measurement target gas by Fourier transform infrared spectroscopic imaging, which is a commonly known technique. In other words, in the gas measuring apparatus, infrared rays from the measurement region are input to a Michelson interferometer in the measuring apparatus, and the moving mirror of the Michelson interferometer is continuously moved. The surface density of the measurement target gas is calculated based on the frequency spectrum of the signal intensity obtained by Fourier-transforming the signal waveform (that is, a temporal interferogram) which is the output waveform of the Michelson interferometer received with the two-dimensional infrared detector.

As a detector configuring one pixel of the two-dimensional infrared detector used in Patent Document 1 in this manner, for example, the bolometer disclosed in Patent Document 2 is known.

A description will be given of the bolometer of Patent Document 2.

FIG. 7 corresponds to FIG. 1 disclosed in Patent Document 2, and is a cross-sectional view schematically showing the structure of a bolometer 50.

The bolometer 50 has a support unit 52, a reflective film 54, and a bolometer thin film 55. The support unit 52 is arranged on a circuit board 51. The reflective film 54 is arranged on the lower surface of a hollow portion 53 of the support unit 52 and on the circuit board 51. The bolometer thin film 55 is arranged on the upper surface of the hollow portion 53 of the support unit 52.

Accordingly, the bolometer 50 has a micro-bridge structure in which a temperature detection unit 56 (diaphragm) including the bolometer thin film 55 is supported in a floating state from the circuit board 51 by the support unit 52.

The bolometer 50 further has a dielectric cover 57, a read circuit 58, a protective film (not shown), and electrode wiring (not shown). The dielectric cover 57 is arranged at a position separated from the top of the temperature detection unit 56 by a distance GAP. The read circuit 58 reads out resistance changes of the bolometer thin film owing to the absorbed infrared rays or terahertz wave. The protective film protects the reflective film and the bolometer thin film. The electrode wiring connects the bolometer thin film and the read circuit. A dielectric cover 57 is fixed on the circuit board 51 by a lid-shaped support member (not shown).

To be exact, the distance GAP shows an interval between the rear surface of the dielectric cover 57 and the center in the thickness direction of the temperature detection unit 56.

The bolometer 50 absorbs the incident light (wavelength λ) 59 at the temperature detection unit 56 through the dielectric cover 57, and, using the read circuit 58, reads out the temperature changes of the bolometer thin film 55 according to the absorption amount of the incident light as changes of the resistance values of the bolometer thin film 55. As a result, it is possible to detect infrared or terahertz light.

The bolometer 50 disclosed in Patent Document 2 also sets the distance GAP to an integer multiple of the half wavelength λ of the incident light. For this reason, it is possible to configure a resonator between the dielectric cover 57 and the temperature detection unit 56, and it is possible to efficiently absorb the incident light 59 at the temperature detection unit 56.

According to Patent Document 2, the absorption rate of the incident light 59 at the temperature detection unit 56 with respect to the wavelength λ in a case where the dielectric cover 57 is present reaches approximately three times the absorption rate in a case where the dielectric cover 57 is not present.

Accordingly, by using the bolometer disclosed in Patent Document 2 as a detector configuring each single pixel of the two-dimensional infrared detector of the gas measuring apparatus of Patent Document 1, it is possible to form a passive type gas detection device using the absorption of light from the infrared region to the terahertz wavelength region.

As an active type gas detection device, for example, as shown in Patent Document 3, a gas sensor in which the output of a laser light source capable of changing the output wavelength is input to an optical waveguide and the output of the optical waveguide is detected with a photodetector is known.

Description will be given of the gas sensor disclosed in Patent Document 3.

FIG. 8 corresponds to FIG. 1 of Patent Document 3, and is a block diagram schematically showing the structure of the gas sensor.

The gas sensor 60 is configured by a laser emitting unit 61 emitting laser light, a light entry opening 62 inputting the laser light emitted by the laser emitting unit to an optical waveguide 63, a light exit opening 65 inputting the laser light passing through the optical waveguide 63 to a photodiode 64, and a microcomputer 66 performing overall control of the operation of the gas sensor 60.

The wavelength of the laser light emitted by the laser light emitting unit 61 is switched to the wavelength of the measurement light and the wavelength of the reference light by laser light switching means (not shown) built into the laser light emitting unit 61.

The wavelength of the measurement light is a wavelength absorbed only by specific gases and the wavelength of the reference light is set to a wavelength not absorbed by the specific gases.

The optical waveguide 63 has a structure in which a waveguide (not shown) in a spiral shape corresponding to the core of an optical fiber is formed in the waveguide substrate (not shown) corresponding to the clad of the optical fiber.

In the gas sensor 60, in the process in which the measurement light is propagated in the optical waveguide 63, an evanescent wave (near-field light wave) of the measurement light seeping onto the optical waveguide is absorbed by the specific gas while the reference light is detected by the photodiode 64 in a state of not being absorbed by the specific gas.

Accordingly, the received light amount of the measurement light at the photodiode 64 decreases when the density of the specific gas in the atmosphere in which the optical waveguide 63 is installed is high, while, the received light amount of the reference light is constant regardless of the density of the specific gas. Therefore, it is possible to detect the density of the specific gas from the ratio of the received light amounts of the measurement light and the reference light in the photodiode 64.

In general, in an active type gas detection device such as the gas sensor 60, since the S/N ratio of the gas detection is increased by increasing the irradiation output of the laser light, there is an advantage in that the gas detection device is easily made more precise in comparison with the passive type gas detection device.

### [Prior Art Documents]

### [Patent Documents]

[Patent Document 1] Japanese Unexamined Patent Application, First Publication No. 2009-174990

[Patent Document 2] Japanese Unexamined Patent Application, First Publication No. 2008-241439

[Patent Document 3] Japanese Unexamined Patent Application, First Publication No. S63-308539

### SUMMARY OF THE INVENTION

### Problem to be Solved by the Invention

However, there is a problem in that, for the detection apparatus disclosed in the above-described Patent Document 1 and Patent Document 2, it is difficult to maintain the S/N ratio of the measuring signal at a favorable level for the passive type detection apparatus.

Meanwhile, the gas sensor disclosed in Patent Document 3 detects the output light from the waveguide with a photodiode. With this configuration, in a case where gas having a strong absorption range in a frequency region reaching the terahertz region and exceeding a frequency region of a wavelength of approximately 1 μm, which is the near infrared region, is detected, there is a problem in that the absolute detection sensitivity of the photodiode is insufficient and highly precise gas detection is difficult.

Further, for the optical waveguide type gas sensor of Patent Document 3, in a case where output light from the waveguide is received by the bolometer disclosed in Patent Document 2 instead of being received by the photodiode, it is difficult to maintain the S/N ratio of the received light signal at a favorable level when the frequency of the input light to the bolometer is changed.

That is, in a case where Patent Document 2 is combined with Patent Document 3, in the case where the bolometer detects light with wavelengths from infrared to terahertz, when a resonator is configured between the bolometer thin film and the dielectric film by the dielectric film arranged on the upper portion of the bolometer thin film as shown in Patent Document 2, the absorption rate of the incident light by the bolometer thin film is increased. Although, in this manner, the detection sensitivity of the input light to the bolometer is increased, as in Patent Document 3, when the input wavelength is changed from the wavelength showing the absorption peak, the detection sensitivity of the bolometer is sharply decreased.

For example, to illustrate the degree of the decrease of the detection sensitivity with reference to Patent Document 2, assuming that the input wavelength to the bolometer 50 shown in FIG. 7 is changed only by approximately 4% from the wavelength λ showing the absorption peak, the absorption rate of the incident light 59 in the temperature detection unit 56 is decreased to an absorption rate of approximately two times or less in comparison with a case where the dielectric cover 57 is not present.

For this reason, to ensure the sensitivity of the gas detection device, it is necessary to improve the absorption rate of the bolometer 50 with respect to the changes of the input wavelength.

An object of the present invention is to provide a highly sensitive gas detection device realized by connecting a bolometer, which is capable of detecting a signal with high sensitivity even when the wavelength of the input signal changes, to a wavelength variable laser and a waveguide.

### Means for Solving the Problem

In order to solve the above problems, some exemplary aspects of the present invention provide a gas detection device as follows.

That is, a gas detection device of the present invention includes: a laser light source which emits wavelength-variable laser light to an optical waveguide; a bolometer which obtains a detection signal by detecting output light from the optical waveguide, and has a microbridge structure having a temperature detection unit and a dielectric member arranged above the temperature detection unit; a detection unit which detects a type and amount of gas molecules present on a surface of the optical waveguide based on the detection signal and information of a wavelength of the laser light source; an optical path length change member which changes an optical path length between the temperature detection unit and the dielectric member; and a driving control circuit which performs driving control of the optical path length change member such that the optical path length becomes an integer multiple of a half wavelength of the laser light emitted from the laser light source.

It is preferable that the optical path length change member is an optical member which is disposed between the temperature detection unit and is the dielectric member having variable refractivity.

In addition, it is preferable that the optical member is a liquid crystal element or an electro-optical (EO) crystal.

### EFFECT OF THE INVENTION

According to a gas detection device of the present invention, it is possible to provide a highly sensitive gas detection device which is capable of detecting a signal with high sensitivity even when the wavelength of the input signal changes and which is realized by connecting a bolometer to a wavelength variable laser and an optical waveguide.

### BRIEF DESCRIPTION OF THE DRAWINGS

FIG. 1 is a block diagram schematically showing the configuration of a gas detection device in a first exemplary embodiment of the present invention.

FIG. 2 is a block diagram schematically showing the configuration of an optical waveguide in the first exemplary embodiment of the present invention.

FIG. 3 is a cross-sectional view schematically showing the configuration of a photodetector in the first exemplary embodiment of the present invention.

FIG. 4 is a block diagram schematically showing the configuration of a gas detection device in the second exemplary embodiment of the present invention.

FIG. 5 is a block diagram schematically showing the configuration of a photodetector in the second exemplary embodiment of the present invention.

FIG. 6 is a cross-sectional view schematically showing the configuration of an optical member in the second exemplary embodiment of the present invention.

FIG. 7 is a cross-sectional view schematically showing the structure of a bolometer of a conventional art.

FIG. 8 is a block diagram schematically showing the structure of a gas sensor of a conventional art.

### EMBODIMENTS FOR CARRYING OUT THE INVENTION

Below, description will be given of some exemplary embodiments of the gas detection device of the present invention. Specific description will be given of these exemplary embodiments in order to improve understanding of the gist of the invention. These exemplary embodiments do not limit the present invention unless particularly specified. In addition, in order to make it easier to understand the characteristics of the exemplary embodiments of the present invention, there are cases where the figures used in the following description enlarge and show the portions which are main parts for convenience. The proportions and the like of each constituent component are not necessarily the same as in practice.

### First Exemplary Embodiment

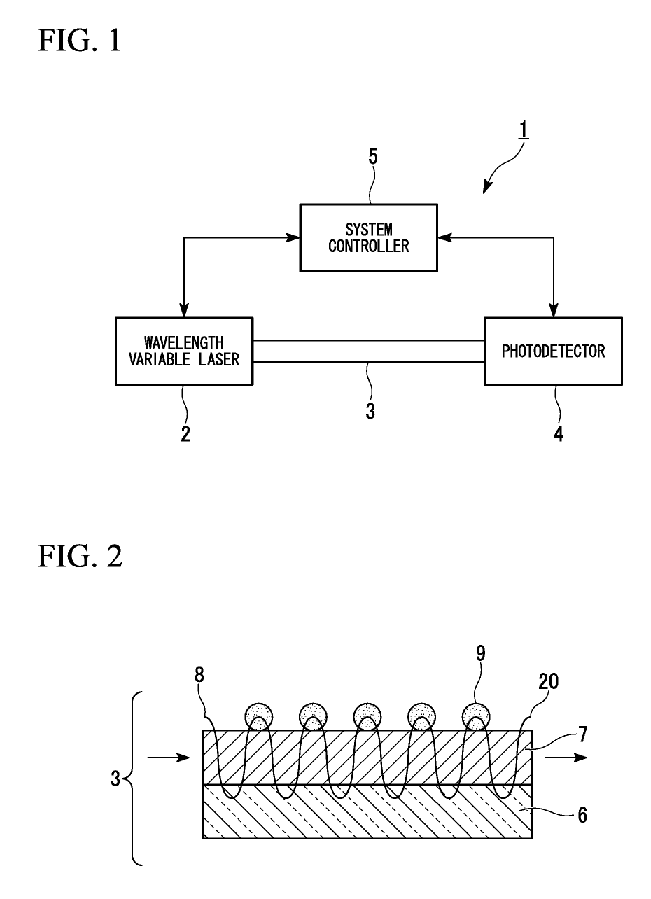

FIG. 1 is a block diagram schematically showing the configuration of a gas detection device of the first exemplary embodiment of the present invention.

The gas detection device 1 includes a wavelength variable laser (laser light source) 2, an optical waveguide 3 to which the laser light emitted by the wavelength variable laser 2 is input, a photodetector 4 receiving a laser light passing through the optical waveguide 3, and a system controller 5 performing overall control of the wavelength variable laser 2 and the photodetector 4.

As the wavelength variable laser 2 of the present exemplary embodiment, there is used an external resonator type wavelength variable laser in which a QCL (Quantum Cascade Laser) is incorporated. By sending a wavelength setting command from the system controller 5 to the wavelength variable laser 2, it is possible to modify the wavelength of the laser emitted light in a range of approximately 9.5 μm to 10.5 μm.

FIG. 2 is a block diagram schematically showing the configuration of the optical waveguide 3.

As the optical waveguide 3, a slab optical waveguide is used. The optical waveguide 3 is formed by providing on the surface of a substrate 6 configured of glass a core 7 of a thin film material having refractivity higher than glass.

The incident light 8 emitted by the wavelength variable laser 2 to the optical waveguide 3 is guided while it is repeatedly totally reflected at the core surface within the core 7. At this time, an evanescent wave is generated up to a distance of approximately the wavelength on the surface of the core 7.

In a case where the gas molecules 9 present on the surface of the core 7 of the optical waveguide 3 exhibit absorption with respect to the wavelength of the laser light being guided, the laser light is guided in the optical waveguide 3 and absorbed in the gas molecules 9, whereby the intensity thereof is gradually reduced.

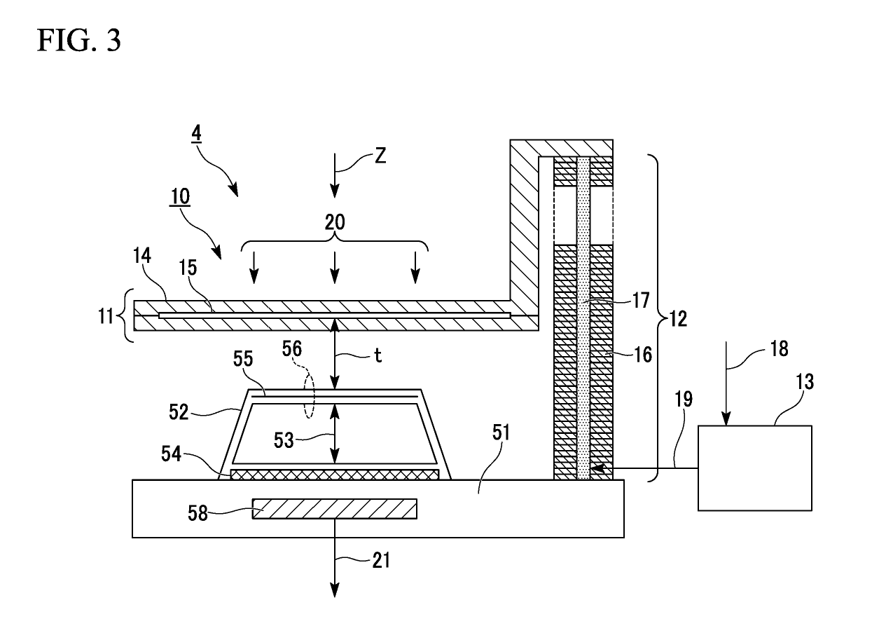

FIG. 3 is a cross-sectional view schematically showing the configuration of the photodetector 4.

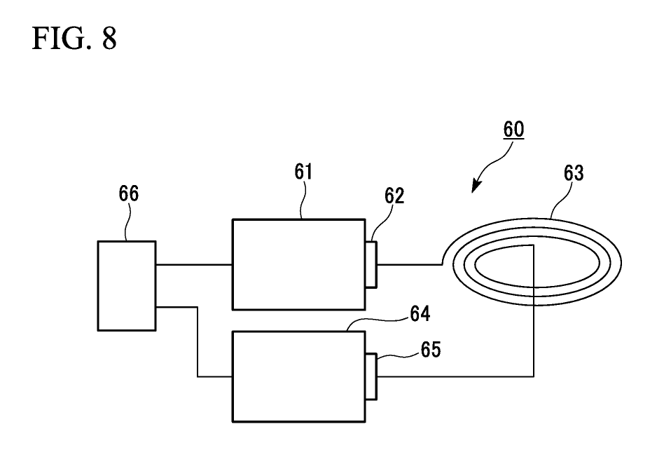

In FIG. 3, the same reference symbols will be given to the same constituent components as in FIG. 7 described above.

In place of the dielectric cover 57 as shown in FIG. 7, the bolometer 10 of the exemplary embodiment of the present invention includes a dielectric member 11, a dielectric member driving mechanism 12, and a driving control circuit 13. The dielectric member driving mechanism 12 moves the dielectric member in the Z direction in FIG. 3. The driving control circuit 13 performs driving control of the dielectric member driving mechanism 12. In the present exemplary embodiment, the dielectric member driving circuit 12 forms an optical path length change member.

The dielectric member 11 has a structure in which a dielectric thin plate 15 formed of the same material as the dielectric cover 57 as shown in FIG. 7 is fixed inside a hollow resin mold 14. One edge of the dielectric member 11 is fixed at the upper surface of the dielectric member driving mechanism 12. The lower surface of the dielectric member driving mechanism 12 is fixed on the circuit board 51.

The emitted light 20 from the optical waveguide 3 passes through the dielectric thin plate 15 and is incident to the temperature detection unit 56.

In the gas detection device 1 in the present exemplary embodiment, a laminated type piezoelectric actuator is used as the dielectric member driving mechanism 12. Specifically, a laminated piezoelectric actuator having a configuration in which approximately 200 layers of approximately 0.1 mm thick piezoelectric ceramics 16 are laminated and both sides thereof are interposed between electrodes 17 is used. In a case where the dielectric member driving mechanism 12 of the present configuration is used, the dielectric thin plate 15 can be moved approximately 15 μm p-p in the Z direction.

As the driving control circuit 13, a piezoelectric actuator driver circuit is used. The driving control circuit 13 applies a driving voltage 19 to the electrode 17 such that the reference command value 18 from the system controller 5 and the distance t between the dielectric thin plate 15 and the temperature detection unit 56 are matched. The dielectric member 11 is attached to the dielectric member driving mechanism 12 such that the distance t includes a distance (that is, 95 μm to 105 μm) of 20 times the half wavelength of the emitted wavelength of the wavelength variable laser 2.

To be exact, the distance t shows the interval between the rear surface of the dielectric thin plate 15 of the dielectric member 11 and the center in the thickness direction of the temperature detection unit 56.

The dielectric member driving mechanism 12 may have another configuration as long as it is possible to secure displacement of the dielectric thin plate 15 in the Z direction of approximately 10 μm or more. For example, when used alongside a friction driving mechanism or the like, the piezoelectric actuator may be miniaturized. Alternatively, the dielectric member driving mechanism 12 may be configured using other types of actuator such as a voice coil type actuator.

The temperature changes of the bolometer thin film 55 according to the absorption amount of the incident light at the temperature detection unit 56 are detected by the read circuit 58 as resistance value changes of the bolometer thin film 55 and sent to the system controller 5 as the detection signal 21.

The system controller (detection unit) 5 calculates the amount and type of the gas molecules 9 present in the atmosphere of the optical waveguide 3 based on information of the detection signal 21 according to information of the wavelength of the laser emitted light shown by the wavelength setting command to the wavelength variable laser 2.

Below, description will be given of the operation of the gas detection device 1 of the first exemplary embodiment of the present invention having the above configuration.

With reference to FIG. 1 and FIG. 3, during quantitative and qualitative analysis of the gas molecules 9 present in the atmosphere of the optical waveguide 3, the system controller 5 issues the reference command value 18 to the driving control circuit 13 such that the distance t inside the photodetector 4 becomes 95 μm. Accordingly, the driving control circuit 13 applies a voltage to the electrode 17 of the laminated piezoelectric actuator of the dielectric member driving mechanism 12 such that the distance t becomes 95 μm.

Next, the system controller 5 sends a wavelength setting command to the wavelength variable laser 2 and laser light having a wavelength of 9.50 μm is emitted from the wavelength variable laser 2.

After the irradiation of the laser light, the system controller 5 converts the information of the detection signal 21 at the time point at which sufficient time (approximately 33 msec) has passed for the detection signal 21 output by the read circuit 58 to become stable into digital data with an A/D converter (not shown) installed in the system controller 5 and extracts it. Next, the system controller 5 stores the digital data and the data of the laser light set wavelength of 9.50 μm, at the address 0 of the memory region (not shown) installed in the system controller 5.

Next, the system controller 5 issues the reference command value 18 to the driving control circuit 13 such that the distance t inside the photodetector 4 becomes 95.1 μm. Accordingly, the driving control circuit 13 applies a voltage to the electrode 17 of the laminated piezoelectric actuator of the dielectric member driving mechanism 12 such that the distance t becomes 95.1 μm.

Next, the system controller 5 sends a wavelength setting command to the wavelength variable laser 2 and laser light having a wavelength of 9.51 μm is emitted from the wavelength variable laser 2.

After the irradiation of the laser light, the system controller 5 A/D converts the data of the detection signal 21 at the time point at which sufficient time has passed for the detection signal 21 output by the read circuit 58 to become stable and extracts it. Next, the system controller 5 stores the digital data and the data of the laser light set wavelength of 9.51 μm, at the address 1 of the memory region (not shown) installed in the system controller 5.

In the following, in the same manner, the system controller 5 moves the distance t inside the photodetector up to 105.0 μm in intervals of 0.1 μm and, together with this, changes the wavelength of the laser light emitted by the wavelength variable laser 2 up to 10.50 μm in intervals of 0.01 μm. Further, the system controller 5 stores the data of the detection signal 21 with respect to the respective wavelengths and the set wavelength data, at the addresses 2 to 100 of the memory region (not shown) installed in the system controller 5.

Next, the system controller 5 uses the data matrix of the detection signal 21 with respect to the laser irradiation wavelength stored at the addresses 0 to 100 of the memory region installed in the above system controller 5 and calculates the data of the type and amount of the gas molecules 9 using known wavelength scanning type spectroscopic imaging.

As described in detail above, by using the gas detection device 1 of the present exemplary embodiment, the distance t between the dielectric thin plate 15 and the temperature detection unit 56 can be always kept at 20 times the half wavelength of the wavelength λ of the incident light. For this reason, it is possible to always configure a resonator between the dielectric thin plate 15 and the temperature detection unit 56, even with a configuration of an active type detection apparatus in which the wavelength of the laser light incident to the bolometer 4 changes, and it is possible to efficiently absorb the emitted light 20 from the optical waveguide 3 in the temperature detection unit 56. As a result, it is possible to realize gas detection with high sensitivity.

In the first exemplary embodiment described above, the range of the wavelength emitted by the wavelength variable laser 2 was taken in the mid-infrared region of around 10 μm but it is not limited thereto. The same effect can be obtained if the range of the wavelength is taken in the terahertz region of around 300 μm, for example.

However, in such a case, it is preferable to use the following configuration and settings. That is, as the wavelength variable laser, for example, a distributed feedback (DFB) tunable diode laser is adopted. The range of the wavelength of the emitted laser is set to from 285 μm to 315 μm. In addition, the range of the distance t is set to 142.5 μm to 157.5 μm. The distance t between the dielectric thin plate 15 and the temperature detection unit 56 is always kept at 1 times the half wavelength of the wavelength λ of the incident light.

### Second Exemplary Embodiment

Below, the second exemplary embodiment of the present invention will be described with reference to the drawings, focusing on the differences to the first exemplary embodiment.

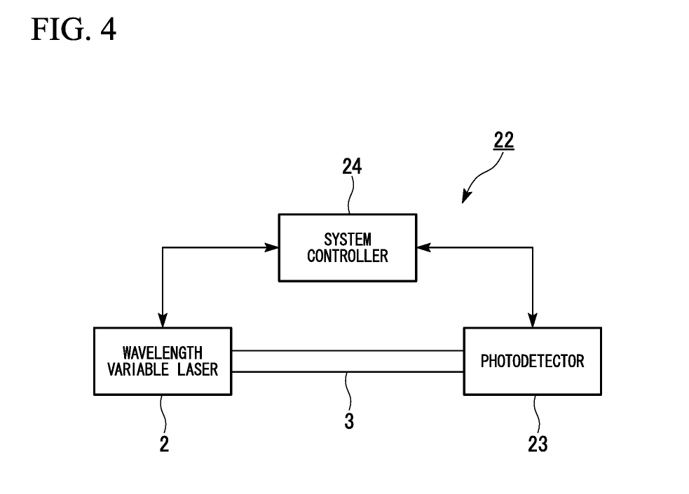

FIG. 4 is a block diagram schematically showing the configuration of the gas detection device 22 of the second exemplary embodiment. In FIG. 4, the same reference symbols will be given to the same constituent components as in the first exemplary embodiment.

In comparison with the first exemplary embodiment, the second exemplary embodiment is different in that it includes a photodetector 23 receiving laser light passing through the optical waveguide 3 and a system controller 24.

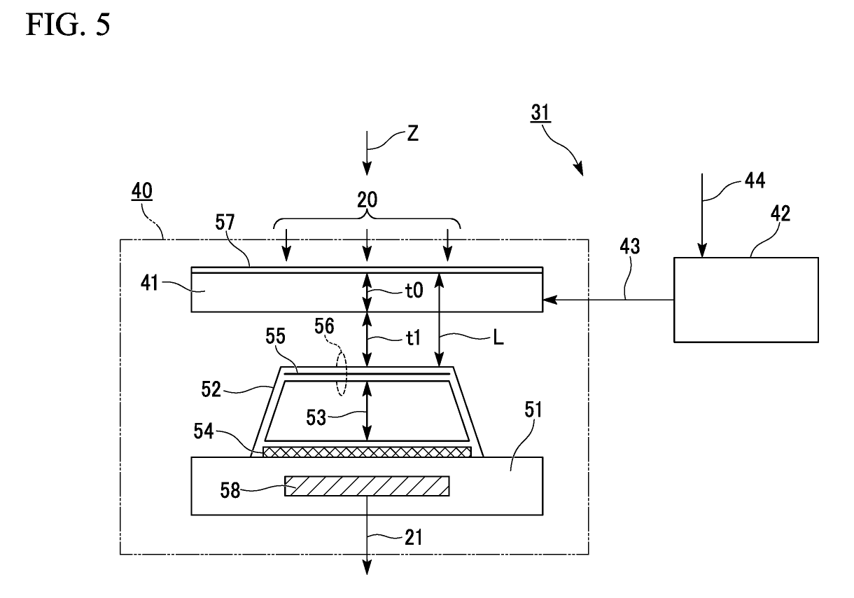

FIG. 5 is a block diagram schematically showing a configuration of the photodetector 23. In FIG. 5, the same reference symbols will be given to the same constituent components as in the first exemplary embodiment. In the present exemplary embodiment, compared with the first exemplary embodiment, the configuration of an optical path length change member is different.

The bolometer 40 of the present exemplary embodiment includes an optical member 41 having a thickness t0 formed of a liquid crystal element below the dielectric cover 57. The dielectric cover 57 is fixed to the circuit board 51 by a lid-shaped support member (not shown). The distance t1 between the lower surface of the optical member 41 and the temperature detection unit 56 is 30 μm.

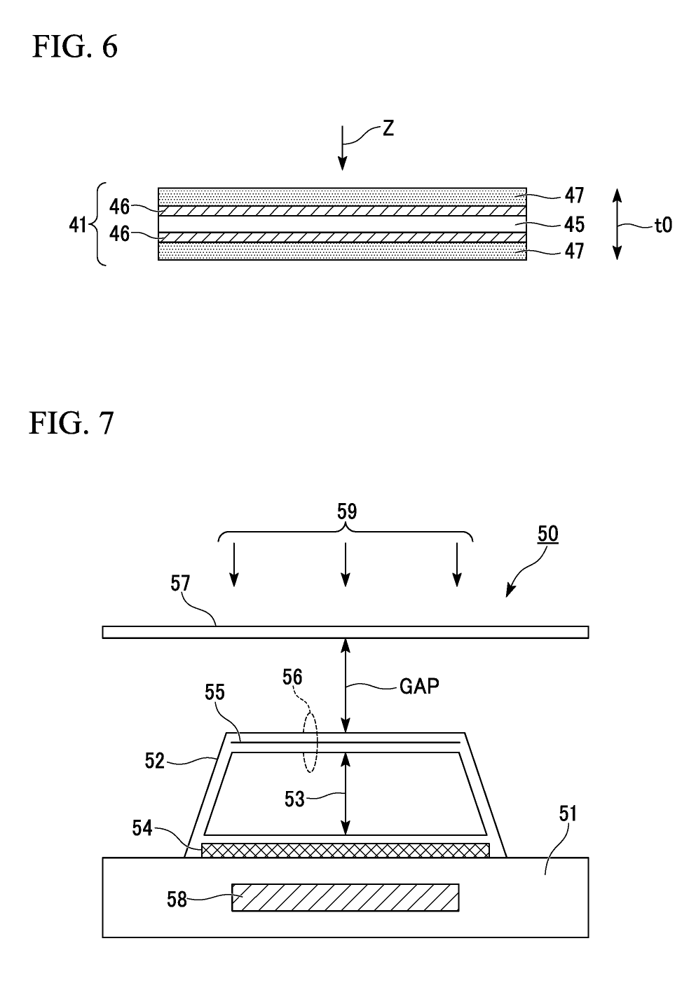

FIG. 6 is a cross-sectional view schematically showing the configuration of the optical member 41.

The optical member 41 of the present exemplary embodiment is realized by interposing a liquid crystal 45 between a transparent electrode 46 and a thin film glass substrate 47. The optical member 41 can change the refractivity in the Z direction of the liquid crystal 45 by applying an amplitude-modulated rectangular wave to the liquid crystal transparent electrode 46. Therefore, it is possible to change the optical path length of light passing through the optical member 41 in the Z direction. That is, in the present exemplary embodiment, the optical member 41 forms an optical path length change member.

In the present exemplary embodiment, nematic liquid crystal is used as the liquid crystal 45. The thickness of the liquid crystal 45 is 20 μm. The thickness of the thin film glass substrates 47 is approximately 50 μm in total. The thickness of the transparent electrodes 46 is approximately 50 nm in total. The thickness t0 of the optical member 41 is designed to be 120 μm.

The refractivity of the liquid crystal 45 is 1.5. The retardation An of the liquid crystal 45 is 0.15. The refractivity of the thin film glass substrate 47 is 1.5. The refractivity of the transparent electrode 56 is 2.0.

Accordingly, since the optical path length of the optical member 41 may be modified in a range of 180 μm to 183 μm, the optical path length L between the dielectric cover 57 and the temperature detection unit 56 can be changed in a range of 210 μm to 213 μm.

To be exact, the optical path length L indicates the optical path length between the rear surface of the dielectric cover 57 and the center in the thickness direction of the temperature detection unit 56.

With reference to FIG. 5 and FIG. 6, based on the reference command value 44 from the system controller 24, the liquid crystal element driving control circuit 42 applies a voltage 43 to the liquid crystal electrode 46 of the optical member 41 to thereby change the refractivity of the liquid crystal 45, so that the optical path length of the optical member 41 is changed.

Description will be given of the operation of the gas detection device 22 of the second exemplary embodiment of the present invention having the above configuration. Here, it is described that the optical path length L between the dielectric cover 57 and the temperature detection unit 56 in the photodetector 23 is always kept at 42 times the half wavelength of the wavelength λ of the emitted light 20 from the optical waveguide 3.

With reference to FIG. 4 and FIG. 5, during quantitative and qualitative analysis of the gas molecules 9 present in the atmosphere of the optical waveguide 3, the system controller 24 issues the reference command value 44 to the driving control circuit 42 such that the optical path length L becomes 210 μm. Accordingly, the driving control circuit 42 applies a voltage 43 to the electrode 46 of the liquid crystal of the optical member 41 such that the optical path length L becomes 210 μm.

Next, the system controller 24 sends a wavelength setting command to the wavelength variable laser 2 and laser light having a wavelength of 10.00 μm is emitted from the wavelength variable laser 2.

After the irradiation of the laser light, the system controller 24 converts the information of the detection signal 21 at the time point at which sufficient time (approximately 33 msec) has passed for the detection signal 21 output by the read circuit 58 to become stable into digital data with an A/D converter (not shown) installed in the system controller 24 and extracts it. Next, the system controller 24 stores the digital data together with the data of the laser light set wavelength of 10.00 μm, at the address 0 of the memory region (not shown) installed in the system controller 24.

Next, the system controller 24 issues the reference command value 44 to the driving control circuit 42 such that the optical path length L becomes 210.21 μm. Accordingly, the driving control circuit 42 applies a voltage 43 to the electrode 46 of the liquid crystal of the optical member 41 such that the optical path length L becomes 210.21 μm.

Next, the system controller 24 sends a wavelength setting command to the wavelength variable laser 2 and laser light having a wavelength of 10.01 μm is emitted from the wavelength variable laser 2.

After the irradiation of the laser light, the system controller 24 A/D converts the data of the detection signal 21 at the time point at which sufficient time has passed for the detection signal 21 output by the read circuit 58 to become stable and extracts it. Next, the system controller 24 stores the data of the detection signal 21 along with the data of the laser light set wavelength of 10.01 μm, at the address 1 of the memory region (not shown) installed in the system controller 24.

In the following, in the same manner, the system controller 24 changes the optical path length L up to 212.94 μm in intervals of 0.21 μm and, together with this, changes the wavelength of the laser light emitted by the wavelength variable laser 2 up to 10.14 μm in intervals of 0.01 μm. Further, the system controller 24 stores the data of the detection signal 21 with respect to the respective wavelengths along with the set wavelength data at the addresses 2 to 14 of the memory region (not shown) installed in the system controller.

Next, the system controller (detection unit) 24 uses the data matrix of the detection signal 21 with respect to the laser irradiation wavelength stored at the addresses 0 to 14 of the memory region installed in the above system controller 24 and calculates the data of the type and amount of the gas molecules 9 using known wavelength scanning type spectroscopic imaging.

Accordingly, using the gas detection device 22 of the present exemplary embodiment, it is possible to realize highly sensitive gas detection in the same manner as the gas detection device of the first exemplary embodiment.

In the second exemplary embodiment of the present invention described above, the optical path length L between the dielectric cover 57 and the temperature detection unit 56 in the photodetector 23 is set to 42 times the half wavelength of the wavelength λ of the emitted light 20 from the optical waveguide 3. However, the magnification may be changed.

In other words, for example, the same effect can be obtained if the magnification is changed to 43 times and the scanning frequency of the wavelength variable laser is changed to be from 9.77 μm to 9.90 μm.

In addition, the spectroscopic imaging may be performed in combination with a plurality of measured data of different magnifications.

In addition, in the second exemplary embodiment described above, a liquid crystal element was used as the optical member but it is not limited thereto. The same effect can be obtained even using another optical member for which the refractivity can be changed as the optical member.

In addition, as the other optical elements, for example, an electro-optic crystal (EO crystal) may be exemplified. The refractivity of the EO crystal change in direct proportion to the electric field applied to the EO crystal.

Specifically, in the case of using a LiNbO₃ crystal as the EO crystal, retardation Δn of the EO crystal is expressed by Δn=0.5×n0³×γ33×EO with the refractivity of the EO crystal being n0, the electro-optical (EO) coefficient being γ33, and the electric field applied to the EO crystal being EO. Therefore, for example, when the retardation Δn at a wavelength of 333 μm is calculated, An becomes 0.093 at a maximum with the maximum value of the applied electric field EO being 200 kV/cm, γ33 being 30.8×10⁻¹⁰ cm/V, and the refractivity n0 of the EO crystal at the wavelength of 333 μm being 6.7. If the thickness of this EO crystal is set to 300 μm, the maximum optical path length that can be changed by the EO crystal becomes 27.9 μm.

Accordingly, it is possible to realize highly sensitive gas detection in the same manner as the first exemplary embodiment and the second exemplary embodiment even if design modifications are carried out in the above manner. That is, the EO crystal is used in place of the optical member 41 of the second exemplary embodiment described above. An EO crystal driving control circuit performing driving control of the electric field applied to the EO crystal is used in place of the liquid crystal element driving control circuit 42. In the EO crystal driving control circuit, the electric field applied to the EO crystal according to the reference command value issued by the system controller is changed so as to perform driving control.

While the invention has been described with reference to exemplary embodiments thereof, the invention is not limited to these embodiments. It will be understood by those of ordinary skill in the art that various changes in form and details of the present invention may be made therein within the scope of the present invention.

This application is based upon and claims the benefit of priority from Japanese patent application No. 2009-261817, filed on Nov. 17, 2009, the disclosure of which is incorporated herein in its entirety by reference.

### INDUSTRIAL APPLICABILITY

The present invention can be applied to a gas detection device. According to this gas detection device, it is possible to detect gas with high sensitivity.

### DESCRIPTION OF REFERENCE SYMBOLS

1 Gas detection device

2 Wavelength variable laser (laser light source)

3 Optical waveguide

4 Photodetector

5 System controller

6 Substrate

7 Core

8 Incident light

9 Gas molecules

10 Bolometer

11 Dielectric member

12 Dielectric member driving mechanism

13 Driving control circuit

14 Resin mold

15 Dielectric thin plate

16 Piezoelectric ceramics

17 Electrode

18 Reference command value

19 Driving voltage

20 Irradiated light

21 Detection signal

22 Gas detection device

23 Photodetector

24 System controller

40 Bolometer

41 Optical member

42 Liquid crystal element driving control circuit

43 Voltage

44 Reference command value

45 Liquid crystal

46 Transparent electrode

47 Thin film glass substrate

50 Bolometer

51 Circuit board

52 Support unit

53 Hollow portion

54 Reflective film

55 Bolometer thin film

56 Temperature detection unit

57 Dielectric cover

58 Read circuit

59 Incident light

60 Gas sensor

61 Laser emitting unit

62 Light entry opening

63 Optical waveguide

64 Photodiode

65 Light exit opening

66 Microcomputer

1. A gas detection device comprising:
a laser light source which emits wavelength-variable laser light to an optical waveguide;
a bolometer which obtains a detection signal by detecting output light from the optical waveguide, and has a microbridge structure having a temperature detection unit and a dielectric member arranged above the temperature detection unit;
a detection unit which detects a type and amount of gas molecules present on a surface of the optical waveguide based on the detection signal and information of a wavelength of the laser light source;
an optical path length change member which changes an optical path length between the temperature detection unit and the dielectric member; and
a driving control circuit which performs driving control of the optical path length change member such that the optical path length becomes an integer multiple of a half wavelength of the laser light emitted from the laser light source.

2. The gas detection device according to claim 1, wherein the optical path length change member is an optical member which is disposed between the temperature detection unit and is the dielectric member having variable refractivity.

3. The gas detection device according to claim 2, wherein the optical member is a liquid crystal element or an electro-optical (EO) crystal.
